(19) United States
(12) Patent Application Publication
(10) Pub. No.: US 2026/0058187 A1
(43) Pub. Date: Feb. 26, 2026

(54) SECONDARY BATTERY

(71) Applicant: Prime Planet Energy & Solutions, Inc., Tokyo (JP)

(72) Inventor: Tomoyuki YAMADA, Kobe-shi (JP)

(21) Appl. No.: 19/290,355

(22) Filed: Aug. 5, 2025

(30) Foreign Application Priority Data
Aug. 22, 2024 (JP) 2024-140543

(51) Int. Cl. H01M 10/04; H01M 10/0563; H01M 50/46; H01M 50/466

(52) U.S. Cl. CPC H01M 10/0422; H01M 10/0459; H01M 50/46; H01M 50/466; H01M 10/0563; H01M 2200/00

(57) ABSTRACT

A case body housing a stacked electrode body and an electrolyte. Positive electrode sheets and negative electrode sheets are stacked, and folded with a separator sandwiched therebetween. The positive electrode sheets and the negative electrode sheets face opposed side surface portions in the cylindrical case body, and are alternately arranged. The stacked electrode body includes a first end portion and a second end portion located in a lower portion thereof. An upper edge of the second end portion is located below a liquid level of the electrolyte.

### CROSS REFERENCE OF RELATED APPLICATION

The present application claims priority from Japanese Patent Application No. 2024-140543 filed on Aug. 22, 2024, which is incorporated by reference herein in its entirety.

### BACKGROUND

The present disclosure relates to a secondary battery.

WO2019/064740 discloses a stacked secondary battery that suppresses occurrence of adverse effects such as deformation of electrodes caused by a folded portion of a separator. In this secondary battery, the separator is folded at ends of electrodes. In the secondary battery disclosed in the patent document mentioned above, the folded portion of the separator is separated from an end of the negative electrode by a predetermined distance. This can suppress occurrence of adverse effects caused by the folded portion of the separator.

An inventor of the present disclosure intends to suppress deterioration of battery characteristics.

### SUMMARY

A secondary battery disclosed here includes: an electrode body including a plurality of first electrode sheets, a plurality of second electrode sheets with a polarity different from that of the first electrode sheets, and a separator; an electrolyte; a cylindrical case body housing the electrode body and the electrolyte; a first sealing plate attached to an opening of the case body on a first side; and a second sealing plate attached to an opening of the case body on a second side, wherein the case body includes a pair of opposed side surface portions, the plurality of first electrode sheets and the plurality of second electrode sheets face the pair of opposed side surface portions in the case body and are alternately arranged, the separator has a band shape, is folded in turn, and sequentially passes between the first electrode sheets and the second electrode sheets to be thereby located between the first electrode sheets and the second electrode sheets, the separator includes a first end portion that is located at an outer circumference of the electrode body in which the plurality of first electrode sheets and the plurality of second electrode sheets alternately face each other, the separator includes a second end portion that is located at the outer circumference of the electrode body in which the plurality of first electrode sheets and the plurality of second electrode sheets are alternately face each other, and overlaid on an outer side of the first end portion and fastened to the outer circumference of the electrode body by a tape, and in a state where the pair of opposed side surface portions of the case body is oriented vertically, an upper edge of the second end portion of the separator fastened by the tape is located below a liquid level of the electrolyte outside the electrode body in the case body.

This secondary battery can suppress deterioration of battery characteristics.

### BRIEF DESCRIPTION OF THE DRAWINGS

FIG. 1 is a perspective view of a power storage device 100 according to a first embodiment.

FIG. 2 is a schematic longitudinal cross-sectional view taken along line A-A in FIG. 1.

FIG. 3 is a transverse cross-sectional view of a stacked electrode body 20.

FIG. 4 is a schematic view illustrating a positive electrode sheet 22 and a negative electrode sheet 24.

FIG. 5 is a schematic view illustrating inside of a case body 12.

FIG. 6 is a rear view of the stacked electrode body 20.

FIG. 7 is a schematic view illustrating inside of the case body 12 when the power storage device 100 is charged.

FIG. 8 is a schematic view illustrating inside of the case body 12 when the power storage device 100 is discharged.

FIG. 9 is a schematic view illustrating inside of a power storage device 100A according to a second embodiment.

FIG. 10 is a schematic view illustrating inside of a power storage device 100B according to a third embodiment.

FIG. 11 is a schematic view illustrating inside of a power storage device 100C according to a fourth embodiment.

### DETAILED DESCRIPTION

The technique disclosed here will be described hereinafter with reference to the drawings. Matters not specifically mentioned herein but required for carrying out the technique disclosed here (e.g., a general configuration and a general fabrication process of a power storage device that do not characterize the technique disclosed here) can be understood as design matter of those skilled in the art based on related art in the field. The technique disclosed here can be carried out on the basis of the contents disclosed herein and common general knowledge in the field. In the drawings, members and parts having the same functions are denoted by the same reference characters, and description will not be repeated or will be simplified.

### First Embodiment

### <Power Storage Device 100>

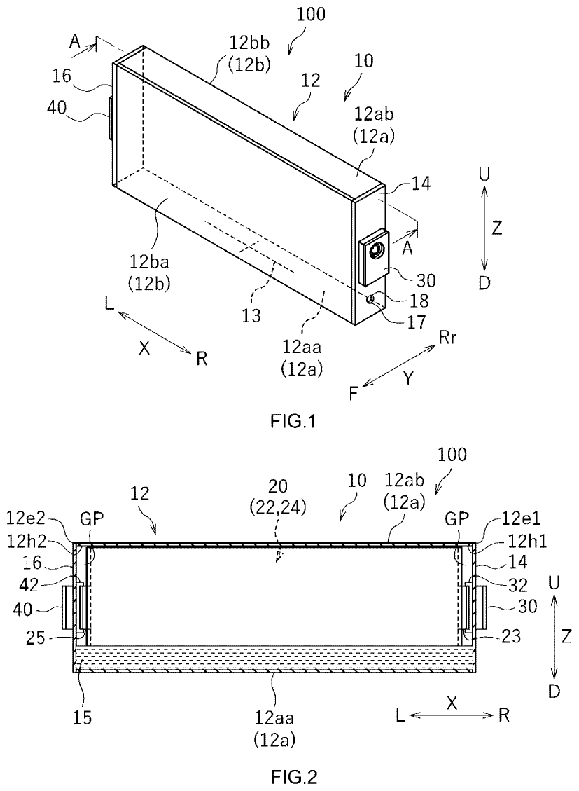

FIG. 1 is a perspective view of a power storage device 100 according to a first embodiment. FIG. 2 is a schematic longitudinal cross-sectional view taken along line A-A in FIG. 1, and illustrates an internal structure of the power storage device 100. As illustrated in FIG. 1, the power storage device 100 has a square shape composed of a hexahedron (specifically, a rectangular parallelepiped shape). The power storage device 100 is installed as illustrated in FIG. 1 in practice. In the following description, characters F, Rr, L, R, U, and D in the drawings represent front, rear, left, right, up, and down, respectively, and characters X, Y, and Z in the drawings respectively represent width directions of the power storage device 100, thickness directions orthogonal to the width directions, and top-bottom directions orthogonal to both the width directions and the thickness directions.

As illustrated in FIG. 1 or 2, the power storage device 100 includes a case 10, a stacked electrode body 20, a positive electrode terminal 30, a negative electrode terminal 40, and an electrolyte 15. The power storage device 100 is a nonaqueous electrolyte secondary battery in this embodiment, and is, for example, a lithium ion secondary battery. The power storage device 100 is configured such that the stacked electrode body 20 and the electrolyte 15 are housed in the case 10 to which the positive electrode terminal 30 and the negative electrode terminal 40 are attached. The term “power storage device” herein refers to a general device capable of being repeatedly charged and discharged, and is a concept that includes secondary batteries such as lithium ion secondary batteries and nickel hydrogen batteries and capacitors such as lithium ion capacitors and electric double layer capacitors.

### <Case 10>

As illustrated in FIG. 2, the case 10 is a housing that houses the stacked electrode body 20 and the electrolyte 15. The outer shape of the case 10 is a flat and bottomed rectangular parallelepiped (square shape) in this embodiment. A material for the case 10 is not particularly limited. The case 10 can be made of a metal such as aluminum or an aluminum alloy, for example. The case 10 includes a case body 12, a first sealing plate 14, and a second sealing plate 16.

### <Case Body 12>

The case body 12 is a cylindrical member that houses the stacked electrode body 20 and the electrolyte 15. In this embodiment, the case body 12 is a cylindrical member having openings at both ends. The case body 12 can be formed by, for example, bending a single metal sheet into a rectangular tubular shape and joining seams together (e.g., by welding). The case body 12 may be formed by joining a plurality of metal sheets.

As illustrated in FIG. 2, the case body 12 includes a pair of narrow surfaces 12a and a pair of wide surfaces 12b. The narrow surfaces 12a are substantially rectangular. The pair of narrow surfaces 12a face each other in the Z directions and constitute an upper surface and a lower surface of the case body 12. The narrow surfaces 12a expand in the X directions and the Y directions. In this embodiment, one of the narrow surfaces 12a on one side in the Z directions (lower side in this embodiment) is also referred to as a bottom surface portion 12aa. The narrow surface 12a on the other side in the Z directions (upper side in this embodiment) is also referred to as a top surface portion 12ab. In the bottom surface portion 12aa and the top surface portion 12ab, the dimensions along the width directions X are longer than the dimensions along the thickness directions Y.

The pair of wide surfaces 12b is an example of a pair of opposed side surface portions in the present disclosure. In the following description, the “wide surfaces 12b” will also be referred to as “side surface portions 12b.” The pair of wide surfaces 12b are substantially rectangular. The pair of wide surfaces 12b is located between the pair of narrow surfaces 12a and continuous with the pair of narrow surfaces 12a. In this embodiment, the long sides of the pair of wide surfaces 12b are connected to the long sides of the pair of narrow surfaces 12a. The pair of wide surfaces 12b are opposed to each other in the X directions, and constitute a front surface and a rear surface of the case body 12. The wide surfaces 12b expand in the Y directions and the Z directions. One of the side surface portions 12b located forward will also be referred to as a side surface portion 12ba. The other of the side surface portions 12b located rearward will also be referred to as a side surface portion 12bb.

As illustrated in FIG. 2, in the width directions X, both ends (end portions 12e1 and 12e2) of the case body 12 have openings 12h1 and 12h2. The openings 12h1 and 12h2 are defined by the short sides of the bottom surface portion 12aa, the side surface portions 12ba and 12bb, and the top surface portion 12ab. The opening 12h1 is formed in the end portion 12e1 on a first side (right side) of the case body 12. The opening 12h2 is formed in the end portion 12e2 on a second side (left side) of the case body 12. The openings 12h1 and 12h2 are substantially rectangular. The stacked electrode body 20 is inserted through the openings 12h1 and 12h2.

### <First Sealing Plate 14, Second Sealing Plate 16>

The first sealing plate 14 is a member attached to the opening 12h1 on the first side of the case body 12. The second sealing plate 16 is a member attached to the opening 12h2 on the second side of the case body 12. The first sealing plate 14 and the second sealing plate 16 are joined to the peripheries of the openings 12h1 and 12h2 of the case body 12. The first sealing plate 14 and the second sealing plate 16 are substantially rectangular plate-shaped members. The first sealing plate 14 and the second sealing plate 16 are joined to the peripheries of the openings 12h1 and 12h2 after the stacked electrode body 20 is housed in the case body 12. The first sealing plate 14 and the second sealing plate 16 joined to the case body 12 face each other in the width directions X. The positive electrode terminal 30 is located on the first sealing plate 14. The negative electrode terminal 40 is located on the second sealing plate 16. A distance between the first sealing plate 14 and the second sealing plate 16 in the width directions X is longer than the length of the stacked electrode body 20 in the width directions X. Thus, a gap GP is formed between the stacked electrode body 20 and each of the first and second sealing plates 14 and 16. The first sealing plate 14 and the second sealing plate 16 may have an injection hole (not shown) for injecting the electrolyte 15 and a safety valve (not shown) that is broken when the internal pressure of the case 10 exceeds a predetermined pressure. The injection hole and the safety valve are located in one of the first sealing plate 14 and the second sealing plate 16, for example.

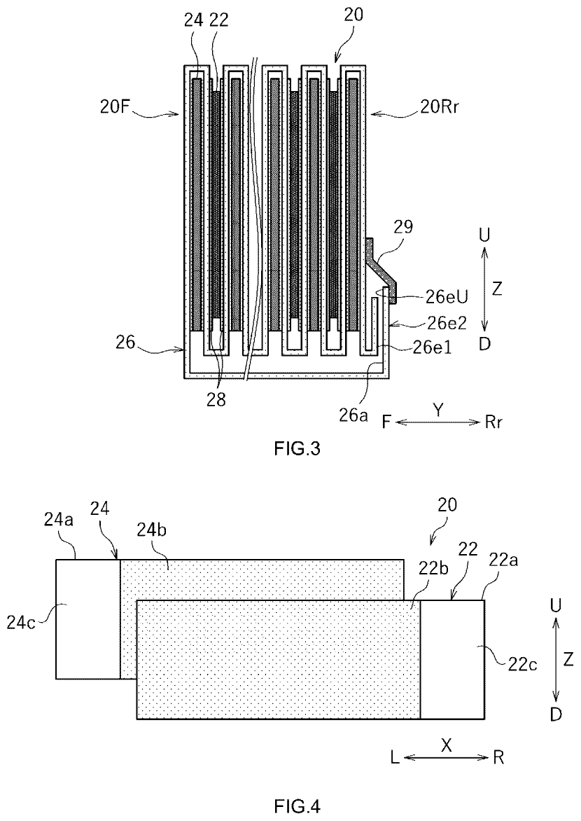

The positive electrode terminal 30 is located on the first sealing plate 14. The positive electrode terminal 30 is an example of a first terminal in the present disclosure. The positive electrode terminal 30 is preferably made of a metal, more preferably made of aluminum or an aluminum alloy, for example. The positive electrode terminal 30 is electrically connected to a positive electrode sheet 22 (see also FIG. 3) described later through a positive electrode current collector 32 in the case 10. The positive electrode terminal 30 may be attached through an insulator (not shown) or a gasket (not shown), for example.

The negative electrode terminal 40 is located on the second sealing plate 16. The negative electrode terminal 40 is an example of a second terminal in the present disclosure. The negative electrode terminal 40 is preferably made of a metal, more preferably made of copper or a copper alloy, for example. The negative electrode terminal 40 is electrically connected to a negative electrode sheet 24 (see also FIG. 3) described later through a negative electrode current collector 42 in the case 10. The negative electrode terminal 40 may be attached through an insulator (not shown) or a gasket (not shown), for example.

The electrolyte 15 is housed in the case 10 together with the stacked electrode body 20. A portion of the electrolyte 15 has infiltrated into the stacked electrode body 20. The electrolyte 15 is a nonaqueous electrolyte including a nonaqueous solvent (organic solvent) and a supporting electrolyte (electrolyte salt, such as lithium salt or sodium salt), for example. Examples of the nonaqueous solvent include carbonates such as ethylene carbonate, dimethyl carbonate, and ethyl methyl carbonate. Examples of the supporting electrolyte includes a fluorine-containing lithium salt such as lithium phosphate hexafluoride (LiPF₆). The electrolyte 15 is typically a liquid but may be a gel. Although not particularly limited, an excess of the electrolyte 15 is preferably present between the case 10 and the stacked electrode body 20. In this embodiment, an excess of the electrolyte 15 is accumulated in the gap GP.

### <Stacked Electrode Body 20>

The stacked electrode body 20 is housed in the case body 12. In this embodiment, two stacked electrode bodies 20 are housed in one case body 12. The two stacked electrode bodies 20 are arranged side by side in the thickness directions Y (see FIG. 5). The number of the stacked electrode bodies 20 disposed in one case body 12 may be one, or three or more. The stacked electrode body 20 may be housed in the case 10 while being covered with a resin insulating sheet (electrode body holder).

FIG. 3 is a transverse cross-sectional view of the stacked electrode body 20. As illustrated in FIG. 3, the stacked electrode body 20 in this embodiment includes a plurality of positive electrode sheets 22, a plurality of negative electrode sheets 24 with a polarity different from that of the positive electrode sheets 22, a separator 26, and an adhesive layer 28 interposed between the positive electrode sheets 22 and the separator 26 and between the negative electrode sheets 24 and the separator 26 in the thickness directions Y. The adhesive layer 28 may be located between the separator 26 and either the positive electrode sheets 22 or the negative electrode sheets 24. The positive electrode sheets 22 and the negative electrode sheets 24 face the pair of opposed side surface portions 12b (see FIG. 1) in the cylindrical case body 12, and the positive electrode sheets 22 and the negative electrode sheets 24 are alternately arranged. The separator 26 has a band shape. The separator 26 is folded in turn and passes sequentially between the positive electrode sheets 22 and the negative electrode sheet 24 to be thereby located between the positive electrode sheets 22 and the negative electrode sheets 24. That is, the separator 26 is folded in a so-called zigzag shape. The stacking directions of the plurality of positive electrode sheets 22 and the plurality of negative electrode sheets 24 are the thickness directions Y in this embodiment. In the following description, the thickness directions Y will also be referred to as stacking directions Y.

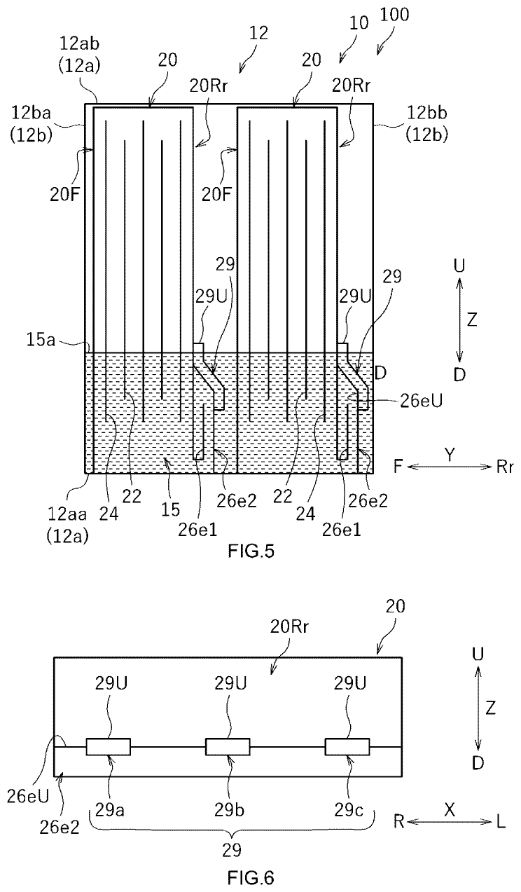

FIG. 4 is a schematic view illustrating the positive electrode sheet 22 and the negative electrode sheet 24. FIG. 4 does not show the separator 26 (see FIG. 3). As illustrated in FIG. 4, the positive electrode sheet 22 includes a positive electrode active material layer 22b, and the negative electrode sheet 24 includes a negative electrode active material layer 24b. Thus, in the stacked electrode body 20, the positive electrode sheet 22 and the negative electrode sheet 24 are stacked to face each other with the positive electrode active material layer 22b and the negative electrode active material layer 24b being insulated from each other. The positive electrode active material layer 22b and the negative electrode active material layer 24b are insulated from each other by the separator 26 (see FIG. 3). In this embodiment, as illustrated in FIG. 3, a side surface of the stacked electrode body 20 to which a tape 29 is fastened is defined as a side surface 20Rr. In this embodiment, the rear surface of the stacked electrode body 20 is the side surface 20Rr. The front surface of the stacked electrode body 20 is defined as a side surface 20F.

As illustrated in FIG. 4, the positive electrode sheet 22 typically includes a positive electrode current collecting foil 22a, and a positive electrode active material layer 22b fixed to at least a surface (both surfaces on both sides in this embodiment) of the positive electrode current collecting foil 22a. The positive electrode current collecting foil 22a is preferably a metal foil. In this embodiment, the positive electrode current collecting foil 22a is made of, for example, aluminum or an aluminum alloy. The positive electrode active material layer 22b includes a positive electrode active material that can reversibly absorb and desorb charge carriers. The positive electrode active material may be similar to that used conventionally and is not particularly limited. Examples of the positive electrode active material include lithium transition metal composite oxides including nickel, cobalt, and manganese. The positive electrode active material layer 22b may include components other than the positive electrode active material, such as a binder and a conductive material. As illustrated in FIG. 3, both surfaces of the positive electrode sheet 22 in the stacking directions Y are bonded to the separator 26 with the adhesive layer 28 interposed therebetween. As illustrated in FIG. 4, an end portion of the positive electrode current collecting foil 22a on one side in the width directions X (right side in the width directions X in this embodiment) includes an uncoated portion 22c including no positive electrode active material layer 22b.

The negative electrode sheet 24 typically includes a negative electrode current collecting foil 24a, and a negative electrode active material layer 24b fixed to at least a surface (both surfaces on both sides in this embodiment) of the negative electrode current collecting foil 24a. The negative electrode current collecting foil 24a is preferably a metal foil. In this embodiment, the negative electrode current collecting foil 24a is made of, for example, copper or a copper alloy. The negative electrode active material layer 24b includes a negative electrode active material that can reversibly absorb and desorb charge carriers. The negative electrode active material may be similar to that used conventionally and is not particularly limited. Examples of the negative electrode active material include a carbon material such as graphite and a silicon-based material. The negative electrode active material layer 24b may include components other than the negative electrode active material, such as a binder, a thickener, and a dispersing agent. As illustrated in FIG. 3, both surfaces of the negative electrode sheet 24 in the width directions X are bonded to the separator 26 with the adhesive layer 28 interposed therebetween. As illustrated in FIG. 4, in this embodiment, an end portion of the negative electrode current collecting foil 24a on one side in the width directions X (left side in the width directions X in this embodiment) includes an uncoated portion 24c including no negative electrode active material layer 24b.

The separator 26 illustrated in FIG. 3 is an insulating sheet having a plurality of minute through holes through which charge carriers can pass. The interposition of the separator 26 between the positive electrode sheets 22 and the negative electrode sheets 24 prevents contact between the positive electrode sheets 22 and the negative electrode sheets 24 and allows charge carriers (e.g., lithium ions) to move between the positive electrode sheets 22 and the negative electrode sheets 24. The thickness of the separator 26 is not particularly limited, and is about 20 μm in this embodiment.

As illustrated in FIG. 3, the separator 26 includes a first end portion 26e1 and a second end portion 26e2. The first end portion 26e1 is located at the outer circumference of the stacked electrode body 20 in which the plurality of positive electrode sheets 22 and the plurality of negative electrode sheets 24 alternately face each other. The second end portion 26e2 is located at the outer circumference of the stacked electrode body 20 in which the plurality of positive electrode sheets 22 and the plurality of negative electrode sheets 24 alternately face each other, and is overlapped on the outer side of the first end portion 26e1 and fastened to the outer circumference of the stacked electrode body 20 by the tape 29. The first end portion 26e1 and the second end portion 26e2 are located rearward of a portion in which the positive electrode sheets 22 and the negative electrode sheets 24 are stacked. The first end portion 26e1 and the second end portion 26e2 are folded back at a substantially right angle from the portion in which the positive electrode sheets 22 and the negative electrode sheets 24 are stacked, and extend in the top-bottom directions Z. That is, the first end portion 26e1 and the second end portion 26e2 are formed in a substantially L shape in a side view. In FIG. 3, a gap is present between the first end portion 26e1 and the second end portion 26e2 in the thickness directions Y, but the gap is relatively narrow in practice. In a portion of the separator 26 that is fastened to the outer circumference of the stacked electrode body 20 by the tape 29 described later, the second end portion 26e2 of the separator 26 is longer than the first end portion 26e1. Thus, an upper edge 26eU of the second end portion 26e2 is located above the first end portion 26e1. A portion of the stacked electrode body 20 including the first end portion 26e1 and the second end portion 26e2 is thicker than the other portion of the stacked electrode body 20 in the thickness directions Y, by the thickness of the first end portion 26e1 and the second end portion 26e2. In this embodiment, the first end portion 26e1 and the second end portion 26e2 are formed in a lower portion of the stacked electrode body 20. Although not particularly limited, in this embodiment, the length of each of the first end portion 26e1 and the second end portion 26e2 in the top-bottom directions Z is about 3 to 10 mm. For convenience of explanation, the first end portion 26e1 and the second end portion 26e2 are exaggerated in the drawings.

The separator 26 includes a resin separator base material and one or more heat resistant layers (HRL) 26a including a metal oxide such as alumina (Al₂O₃). In this embodiment, the separator 26 includes the heat resistant layer 26a on at least one side thereof. In this embodiment, the heat resistant layer 26a is formed on the inner side of the second end portion 26e2 of the separator 26 in the portion of the separator 26 fastened to the outer circumference of the stacked electrode body 20 by the tape 29 described later.

The heat resistant layer 26a typically includes an inorganic filler ad a heat resistant layer binder. The presence of the heat resistant layer 26a suppresses heat contraction of the separator 26 and contributes to enhancement of safety of the power storage device 100 (see FIG. 1). The inorganic filler is preferably ceramic particles such as alumina, zirconia, boehmite, aluminum hydroxide, silica, and titania, and from the viewpoint of suppressing heat contraction of the separator 26, is particularly preferably a compound containing aluminum. Examples of the heat resistant layer binder include an acrylic resin, a fluorine-based resin, a urethane resin, ethylene vinyl acetate resin, and an epoxy resin.

FIG. 6 is a rear view of the stacked electrode body 20. As described above, the tape 29 fastens the second end portion 26e2. As illustrated in FIG. 6, the tape 29 includes a first tape 29a, a second tape 29b, and a third tape 29c intermittently arranged along the upper edge 26eU of the second end portion 26e2. In this embodiment, the upper edge 26eU of the second end portion 26e2 extends in the width directions X. Thus, the first tape 29a, the second tape 29b, and the third tape 29c are arranged along the width directions X. In this embodiment, the first tape 29a, the second tape 29b, and the third tape 29c constitute the tape 29, but the number of tapes constituting the tape 29 is not particularly limited. In the following description, the “tape 29” refers to the first tape 29a, the second tape 29b, and the third tape 29c, unless otherwise specified. As illustrated in FIG. 5, in this embodiment, an upper end 29U of the tape 29 is located above a liquid level 15a of the electrolyte 15. The thickness of the tape 29 is, but not particularly limited to, about 50 μm in this embodiment. As illustrated in FIG. 3, in the portion of the stacked electrode body 20 to which the tape 29 is fastened, the length of the stacked electrode body 20 in the thickness directions Y is long. A portion where the first end portion 26e1, the second end portion 26e2, and the tape 29 overlap in the stacking directions Y is the thickest portion of the stacked electrode body 20. The portion of the stacked electrode body 20 where the first end portion 26e1, the second end portion 26e2, and the tape 29 overlap in the stacking directions Y will be hereinafter referred to as the “thickest portion.”

FIG. 5 is a schematic view illustrating inside of the case body 12. As illustrated in FIG. 5, two stacked electrode bodies 20 are arranged side by side in the thickness directions Y. In the two stacked electrode bodies 20, in a state where the pair of opposed side surface portions 12b of the case body 12 are oriented vertically, the upper edge 26eU of the second end portion 26e2 of the separator 26 fastened by the tape 29 is located below the liquid level 15a of the electrolyte 15 outside the stacked electrode bodies 20 in the case body 12. The expression “in the state where the pair of opposed side surface portions 12b is oriented vertically” refers to an orientation when the case body 12 is placed with one of the pair of narrow side surfaces (bottom surface portion 12aa in this embodiment) being located below and the pair of side surface portions 12b as the wide surfaces being located substantially perpendicular to one of the pair of narrow side surfaces, as illustrated in FIG. 5. In this embodiment, the height of the liquid level 15a of the electrolyte 15 varies depending on the state of charge (SOC) of the power storage device 100. In this embodiment, in a state where the SOC of the power storage device 100 is 75% or more, the upper edge 26eU of the second end portion 26e2 is located below the liquid level 15a of the electrolyte 15. That is, in the state where the SOC of the power storage device 100 is 75% or more, the first end portion 26e1 and the second end portion 26e2 of the separator 26 fastened by the tape 29 are located below the liquid level 15a of the electrolyte 15. For convenience of explanation, FIG. 5 shows gaps between the stacked electrode bodies 20 and the side surface portions 12b, but the stacked electrode bodies 20 may be in contact with the side surface portions 12b. The expression “the SOC is 75% or more” means that the SOC in a state where the power storage device 100 is new or relatively close to new is 75% or more.

As illustrated in FIG. 5, the side surfaces 20Rr of the two stacked electrode bodies 20 to which the tapes 29 are fastened are oriented toward the same side of the pair of opposed side surface portions 12b of the case body 12. In this embodiment, the side surfaces 20Rr of the two stacked electrode bodies 20 are both oriented toward the side surface portion 12bb. The side surfaces 20Rr of the two stacked electrode bodies 20 may be oriented toward the side surface portion 12ba.

As illustrated in FIG. 2, the positive electrode sheet 22 includes a positive electrode tab 23 extending toward the first sealing plate 14 and connected to the positive electrode terminal 30. Each of the plurality of positive electrode sheets 22 includes the positive electrode tab 23. The positive electrode tab 23 is a portion in which the positive electrode current collecting foil 22a (see FIG. 4) protrudes from a region where the positive electrode active material layer 22b (see FIG. 4) and the negative electrode active material layer 24b (see FIG. 4) are overlapped. The positive electrode tab 23 is formed by overlapping the uncoated portion 22c (see FIG. 4). The positive electrode tab 23 is electrically connected to the positive electrode terminal 30 through the positive electrode current collector 32. The negative electrode sheet 24 includes a negative electrode tab 25 extending toward the second sealing plate 16 and connected to the negative electrode terminal 40. Each of the plurality of negative electrode sheets 24 includes the negative electrode tab 25. The negative electrode tab 25 is a portion in which the negative electrode current collecting foil 24a (see FIG. 4) protrudes from a region where the negative electrode active material layer 24b (see FIG. 4) and the negative electrode active material layer 24b (see FIG. 4) are overlapped. The negative electrode tab 25 is formed by overlapping the uncoated portion 24c (see FIG. 4). The negative electrode tab 25 is electrically connected to the negative electrode terminal 40 through the negative electrode current collector 42. The positive electrode tab 23 is an example of a first electrode tab in the present disclosure. The negative electrode tab 25 is an example of a second electrode tab in the present disclosure.

The adhesive layer 28 illustrated in FIG. 3 is interposed between the separator 26 and at least one of the positive electrode sheets 22 or the negative electrode sheets 24, and bonds the separator 26 and the at least one of the positive electrode sheets 22 or the negative electrode sheets 24. This suppresses positional displacement of the positive electrode sheets 22 and the negative electrode sheets 24. Consequently, displacement in stacking the stacked electrode bodies 20 is suppressed. In FIG. 3, in the stacking directions Y, both surfaces of each of the positive electrode sheets 22 and both surfaces of each of the negative electrode sheets 24 are bonded to the separator 26 facing these surfaces with the adhesive layer 28 interposed therebetween.

The adhesion layer 28 is typically a layer that contains a adhesive layer binder with the highest mass percentage. Examples of the adhesive layer binder include resins such as a fluorine-based resin, an acrylic resin, a urethane resin, an ethylene vinyl acetate resin, and an epoxy resin. The adhesive layer binder may be of the same type as the heat resistant layer binder described above, or may be of a different type. The adhesive layer 28 may further include another material (e.g., an inorganic filler).

The configuration of the power storage device 100 according to this embodiment has been described above. When the power storage device 100 is charged and discharged, the positive electrode active material layer 22b (see FIG. 4) and the negative electrode active material layer 24b (see FIG. 4) expand and contract, and accordingly, the stacked electrode body 20 expands and contracts. When the stacked electrode body 20 expands, the electrolyte 15 that has infiltrated into the stacked electrode body 20 is partially extruded. When the stacked electrode body 20 contracts, the electrolyte 15 is partially absorbed in the stacked electrode body 20. In this embodiment, if the thickness of the stacked electrode body 20 is not uniform, a force applied to the stacked electrode body 20 during expansion and contraction of the stacked electrode body 20 is not uniform. In this state, when the electrolyte 15 is repeatedly extrude and absorbed, shortage of the electrolyte 15 (i.e., so-called liquid shortage) might occur in some portions. When the liquid shortage occurs, battery characteristics of the power storage device 100 deteriorate. The inventor of the present application intends to suppress deterioration of battery characteristics when the electrolyte 15 is repeatedly extruded and absorbed.

Next, the electrolyte 15 in the power storage device 100 when the power storage device 100 is charged and discharged will be described.

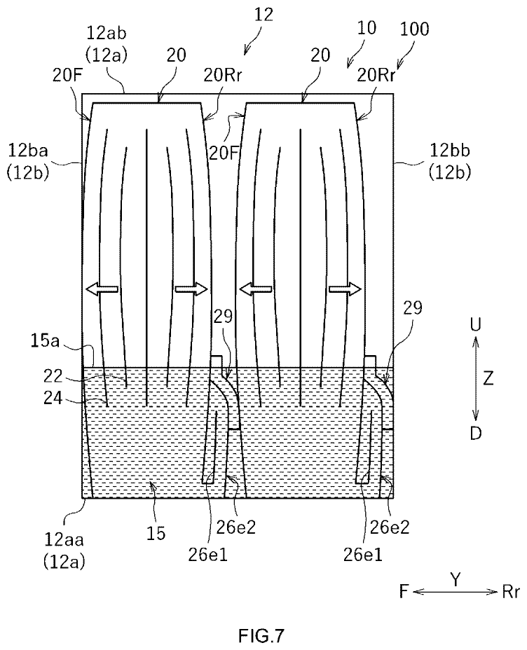

First, charge of the power storage device 100 is described. The power storage device 100 is charged by a known method. FIG. 7 is a schematic view illustrating inside of the case body 12 when the power storage device 100 is charged. When the power storage device 100 is charged, the positive electrode active material layer 22b (see FIG. 4) and the negative electrode active material layer 24b (see FIG. 4) expand as described above. As described above, the positive electrode sheets 22 and the negative electrode sheets 24 are stacked along the thickness directions Y. At this time, as illustrated in FIG. 7, the positive electrode sheets 22 and the negative electrode sheets 24 are curved to bulge toward the outside of the stacked electrode body 20. Accordingly, the stacked electrode body 20 expand to spread in the thickness directions Y.

When the stacked electrode body 20 expands, the stacked electrode body 20 pushes the pair of side surface portions 12b toward the outside in the thickness directions Y. At this time, the stacked electrode body 20 receives a normal force from the pair of side surface portions 12b. Here, a rear one of the two stacked electrode bodies 20 arranged side by side (hereinafter referred to as a “rear stacked electrode body 20”) faces the side surface portion 12bb in the thickest portion thereof, and thus, the tape 29 is in contact with the side surface portion 12bb. The side surface 20F of the rear stacked electrode body 20 is in contact with the tape 29 of a front one of the two stacked electrode bodies 20 arranged side by side (hereinafter referred to as a “front stacked electrode body 20”). Thus, a force is likely to be applied to the rear stacked electrode body 20 toward the inside in the thickness directions Y in the vicinity of the thickest portion. Here, the vicinity of the thickest portion is a range including at least one of the first end portion 26e1, the second end portion 26e2, or the tape 29 of the stacked electrode body 20. In this embodiment, the vicinity of the thickest portion is a range in the stacked electrode body 20 at the position of the upper end 29U of the tape 29 and below the upper end 29U of the tape 29 in the top-bottom directions Z.

The tape 29 of the front stacked electrode body 20 is in contact with the rear stacked electrode body 20. A most expanded portion of the side surface 20F of the front stacked electrode body 20 is in contact with the side surface portion 12ba. In this embodiment, a portion near the center of the side surface 20F in the top-bottom directions Z is in contact with the side surface portion 12ba. Thus, in the front stacked electrode body 20, a force is likely to be applied inward in the thickness directions Y near the center of the side surface 20F in the top-bottom directions Z, whereas a force is likely to be applied inward in the thickness directions Y near the thickest portion of the side surface 20Rr. In the stacked electrode body 20, since none of the first end portion 26e1, the second end portion 26e2, and the tape 29 is present in a range above the tape 29, this range is thinner than the other range of the stacked electrode body 20 in the thickness directions Y. Thus, in the range above the tape 29 in the stacked electrode body 20, a force applied inward in the thickness directions Y is relatively small.

When a force is applied inward in the thickness directions Y to each of the two stacked electrode bodies 20, the electrolyte 15 that has infiltrated into the stacked electrode bodies 20 are extruded. Since the stacked electrode bodies 20 are pushed inward in the thickness directions Y, the electrolyte 15 is extruded outward in the width directions X. In this embodiment, since a force is applied to the vicinity of the thickest portion of the stacked electrode body 20, the electrolyte 15 that has infiltrated near the thickest portion is likely to be extruded. The extruded electrolyte 15 is accumulated in the case body 12. More specifically, the extruded electrolyte 15 is accumulated in a lower portion of the case body 12 by gravity. Thus, as illustrated in FIG. 2, the electrolyte 15 is accumulated in a lower portion of the case body 12. At this time, the electrolyte 15 is also accumulated in gaps GP (see FIG. 2) at the right and left of the stacked electrode body 20. In the range above the tape 29 in the stacked electrode body 20, since a force applied inward in the thickness directions Y is relatively small, the electrolyte 15 is less likely to be extruded as compared to the vicinity of the thickest portion.

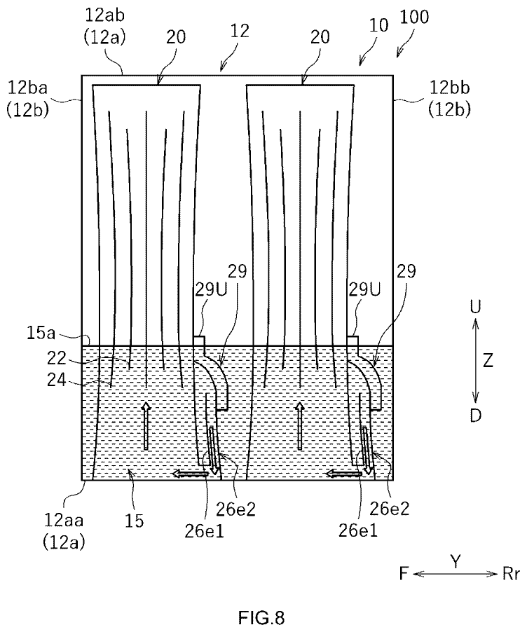

Then, discharging of the power storage device 100 will be described. The power storage device 100 is discharged when a vehicle (not shown) equipped with the power storage device 100 travels, for example. FIG. 8 is a schematic view illustrating inside of the case body 12 when the power storage device 100 is discharged. When the power storage device 100 is discharged, the positive electrode active material layer 22b (see FIG. 4) and the negative electrode active material layer 24b (see FIG. 4) contract as described above. At this time, as illustrated in FIG. 8, the positive electrode sheet 22 and the negative electrode sheet 24 are curved inward in the thickness directions Y. Accordingly, the stacked electrode body 20 contracts in the thickness directions Y.

When the stacked electrode body 20 contracts, the electrolyte 15 accumulated in the case body 12 is absorbed in the stacked electrode body 20. In this embodiment, the separator 26 is attached to cover the positive electrode sheet 22 and the negative electrode sheet 24 in the thickness directions Y. Accordingly, the positive electrode sheet 22 and the negative electrode sheet 24 are not covered with the separator 26 in the width directions X. Thus, the stacked electrode body 20 mainly absorbs the electrolyte 15 accumulated in the gaps GP (see FIG. 2) at the left and right of the stacked electrode body 20. Since the electrolyte 15 is accumulated in a lower portion of the case body 12, the electrolyte 15 is absorbed from the lower portion of the stacked electrode body 20. When the electrolyte 15 cannot be absorbed in the lower portion of the stacked electrode body 20 any more, the electrolyte 15 is gradually absorbed in an upper portion of the stacked electrode body 20.

A distance between the first end portion 26e1 and the second end portion 26e2 is relatively narrow. Thus, as the electrolyte 15 is gradually absorbed in the upper portion of the stacked electrode body 20, the electrolyte 15 that has entered between the first end portion 26e1 and the second end portion 26e2 is absorbed toward the positive electrode sheets 22 and the negative electrode sheets 24. That is, as indicated by the arrows in FIG. 8, the electrolyte 15 between the first end portion 26e1 and the second end portion 26e2 passes through a substantially right-angled portion of the first end portion 26e1 and the second end portion 26e2 and moves toward the positive electrode sheets 22 and the negative electrode sheets 24 by a capillary action.

As described above, in the power storage device 100 according to this embodiment, the case body 12 houses the stacked electrode bodies 20 and the electrolyte 15. In each of the stacked electrode bodies 20, the positive electrode sheets 22 and the negative electrode sheets 24 are stacked and folded with the separator 26 sandwiched between the positive electrode sheets 22 and the negative electrode sheets 24. The positive electrode sheets 22 and the negative electrode sheets 24 face the pair of opposed side surface portions 12b in the cylindrical case body 12, and are alternately arranged. When the power storage device 100 is charged and discharged, the electrolyte 15 that has infiltrated into the stacked electrode body 20 is extruded or absorbed mainly in the width directions X. That is, when the power storage device 100 is charged and discharged, the electrolyte 15 is extruded into the gaps GP and the electrolyte 15 accumulated in the gaps GP is absorbed in the stacked electrode body 20. The stacked electrode body 20 includes the first end portion 26e1 and the second end portion 26e2. The tape 29 is fastened to the second end portion 26e2. Thus, when the power storage device 100 is charged and the stacked electrode body 20 expands and contacts the pair of side surface portions 12b, a relatively large force is applied to the vicinity of the thickest portion of the stacked electrode body 20. Thus, the electrolyte 15 is likely to be extruded from the vicinity of the thickest portion of the stacked electrode body 20. The upper edge 26eU of the second end portion 26e2 is located below the liquid level 15a of the electrolyte 15. Thus, a whole or a part of the vicinity of the thickest portion is immersed in the electrolyte 15. Accordingly, when the electrolyte 15 is extruded from the vicinity of the thickest portion and then the stacked electrode body 20 contracts, the electrolyte 15 is likely to be absorbed in the vicinity of the thickest portion. That is, in the stacked electrode body 20, a portion where the electrolyte 15 is likely to be extruded during charge coincides with a portion where the electrolyte 15 is likely to be absorbed during discharge. This suppresses occurrence of liquid shortage in the stacked electrode body 20. Consequently, deterioration of battery characteristics caused by liquid shortage during charge and discharge is suppressed in the power storage device 100.

In the power storage device 100 according to this embodiment, the upper end 29U of the tape 29 is located above the liquid level 15a of the electrolyte 15. Accordingly, the electrolyte 15 included in a region sandwiched between the first end portion 26e1 and the second end portion 26e2 does not flow between the separator 26 and the tape 29, but flows below the tape 29 as indicated by the arrows in FIG. 8 and is absorbed in the positive electrode sheets 22 and the negative electrode sheets 24. In this manner, the absorbed electrolyte 15 relatively easily circulates in the stacked electrode body 20.

In the power storage device 100 according to this embodiment, the tapes 29 are intermittently arranged along the upper edge 26eU of the second end portion 26e2, as illustrated in FIG. 6. Accordingly, a normal force applied from the case body 12 during charge of the power storage device 100 differs between a portion of the second end portion 26e2 to which the tape 29 is fastened and a portion of the second end portion 26e2 to which the tape 29 is not fastened. That is, a larger force is applied to the portion to which the tape 29 is fastened than the portion to which the tape 29 is not fastened. This causes a pressure difference between the portion of the second end portion 26e2 to which the tape 29 is fastened and the portion of the second end portion 26e2 to which the tape 29 is not fastened when the stacked electrode body 20 expands and contracts by charging and discharging the power storage device 100. This pressure difference serves as a driving force for moving the electrolyte 15 in the stacked electrode body 20. Thus, occurrence of the pressure difference causes the electrolyte 15 to easily spread in the stacked electrode body 20. Consequently, liquid shortage caused by charge and discharge is further suppressed in the power storage device 100.

In the power storage device 100 according to this embodiment, the second end portion 26e2 is longer than the first end portion 26e1 in the top-bottom directions Z. Thus, the second end portion 26e2 is fastened to cover the first end portion 26e1 above the upper end of the first end portion 26e1. This suppresses loosening of the separator 26.

In the power storage device 100 according to this embodiment, the heat resistant layer 26a is located on an inner side of the second end portion 26e2. The second end portion 26e2 constitutes an outermost portion of the separator 26. Thus, since the heat resistant layer 26a is located on the inner side of the second end portion 26e2, even when a short circuit occurs in the stacked electrode body 20, it is possible to suppress spread of fire.

In the power storage device 100 according to this embodiment, in a state where the SOC of the power storage device 100 is 75% or more, the first end portion 26e1 and the second end portion 26e2 are located below the liquid level 15a of the electrolyte 15. Since the electrolyte 15 that has infiltrated into the stacked electrode body 20 moves in and out of the case body 12 by charging and discharging of the power storage device 100, the height of the liquid level 15a of the electrolyte 15 changes in the middle of charge and discharge. The inventor of the present application found that when the SOC of the power storage device 100 in the state where the first end portion 26e1 and the second end portion 26e2 are located below the liquid level 15a of the electrolyte 15 is set at 75% or more, the electrolyte 15 is absorbed in the vicinity of the thickest portion of the power storage device 100 so that liquid shortage is thereby suppressed. Accordingly, the configuration in which the first end portion 26e1 and the second end portion 26e2 are located below the liquid level 15a of the electrolyte 15 in the state where the SOC of the power storage device 100 is 75% or more is a specific aspect for obtaining advantages of the present disclosure.

In the power storage device according to this embodiment, in the state where the pair of side surface portions 12b is oriented vertically, the upper edge 26eU of the second end portion 26e2 of each of the two stacked electrode bodies 20 is located below the liquid level 15a of the electrolyte 15. Thus, even in a case where the power storage device 100 includes a plurality of stacked electrode bodies 20, liquid shortage can be suppressed in each of the stacked electrode bodies 20.

In the power storage device 100 according to this embodiment, the side surface 20Rr of each of the two stacked electrode bodies 20 is oriented toward the side surface portion 12ba. Accordingly, in the two stacked electrode bodies 20, the separators 26 are folded in the same direction. Thus, in fabrication of the power storage device 100, it is sufficient to prepare two stacked electrode bodies 20 in which the separators 26 are folded in the same direction. Consequently, a burden in fabricating the power storage device 100 is reduced so that productivity of the power storage device 100 can be thereby enhanced.

In the power storage device 100 according to this embodiment, the positive electrode tab 23 extends toward the first sealing plate 14 and is connected to the positive electrode terminal 30. The positive electrode terminal 30 is located on the first sealing plate 14. The negative electrode tab 25 extends toward the second sealing plate 16 and is connected to the negative electrode terminal 40. The negative electrode terminal 40 is located on the second sealing plate 16. Thus, in this embodiment, the first sealing plate 14, the positive electrode terminal 30, the positive electrode tab 23, the second sealing plate 16, the negative electrode terminal 40, and the negative electrode tab 25 are arranged in the width directions X. Since there components are arranged in the width directions X, the length of the stacked electrode body 20 in the top-bottom directions Z can be made relatively uniform. Accordingly, the length of the case body 12 in the top-bottom directions Z can be made close to the length of the stacked electrode body 20 in the top-bottom directions Z so that a filling factor of the stacked electrode body 20 in the case body 12 can be thereby made relatively high. Thus, the extruded electrolyte 15 is relatively likely to be accumulated in the gaps GP. The electrolytes 15 accumulated in the gaps GP is absorbed during discharge of the power storage device 100. Consequently, the electrolyte 15 is relatively likely to circulate inside and outside the stacked electrode body 20.

The power storage device 100 according to the first embodiment has been described above. The first embodiment described above, however, is merely an example, and the present disclosure can be performed in various modes.

### Second Embodiment

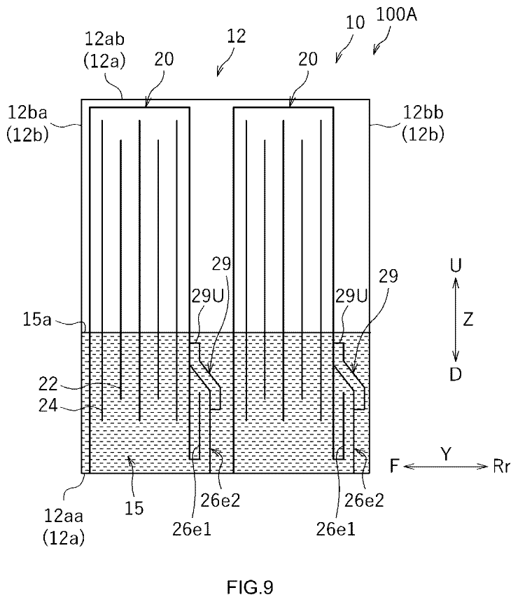

FIG. 9 is a schematic view illustrating inside of a power storage device 100A according to a second embodiment. In the following description of the second embodiment, members having the same functions as those of the first embodiment are denoted by the same reference characters. Description for the same members and parts will not be repeated or will be simplified. The same holds for a third embodiment and a fourth embodiment described later.

As illustrated in FIG. 9, in the second embodiment, an upper end 29U of a tape 29 is located below a liquid level 15a of an electrolyte 15.

In a manner similar to the first embodiment, when the power storage device 100A is charged, a large force is applied to a vicinity of a thickest portion of each stacked electrode body 20 Accordingly, the electrolyte 15 that has infiltrated into the vicinity of the thickest portion of the stacked electrode body 20 is extruded. Since the upper end 29U of the tape 29 is located below the liquid level 15a of the electrolyte 15, the vicinity of the vicinity of the thickest portion of the stacked electrode body 20 is located below the liquid level 15a of the electrolyte 15. In a manner similar to the first embodiment, when the power storage device 100 is discharged, the stacked electrode body 20 contracts and the electrolyte 15 is absorbed.

In the second embodiment described above, the upper end 29U of the tape 29 is located below the liquid level 15a of the electrolyte 15. The stacked electrode body 20 receives a pressure from the electrolyte 15 at a position below the liquid level 15a of the electrolyte 15. In this embodiment, since the upper end 29U is located below the liquid level 15a of the electrolyte 15, a relatively large part of the stacked electrode body 20 is immersed in the electrolyte 15. Thus, a pressure by the electrolyte 15 is applied to a relatively large area of the stacked electrode body 20. Accordingly, the electrolyte 15 that has infiltrated into the stacked electrode body 20 is relatively likely to be pushed upward in the stacked electrode body 20. This suppresses occurrence of liquid shortage of the electrolyte 15 in the stacked electrode body 20.

### Third Embodiment

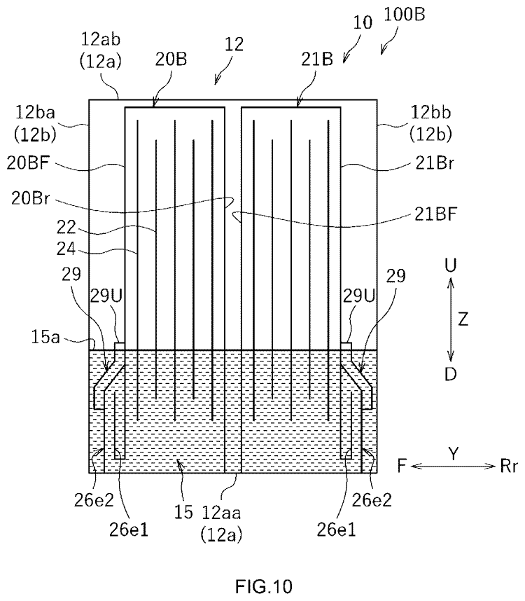

FIG. 10 is a schematic view illustrating inside of a power storage device 100B according to a third embodiment. As illustrated in FIG. 10, a stacked electrode body 20B and a stacked electrode body 21B are housed in a case 10. The stacked electrode body 20B is located forward of the stacked electrode body 21B. A side surface of the stacked electrode body 20B to which a tape 29 is fastened will be referred to as a side surface 20BF. A surface of the stacked electrode body 20B opposite to the side surface 20BF in the thickness directions Y will be referred to as a side surface 20Br. A side surface of the stacked electrode body 21B to which the tape 29 is fastened will be referred to as a side surface 21Br. A surface of the stacked electrode body 21B opposite to the side surface 21Br in the thickness directions Y will be referred to as a side surface 21BF. The side surface 20BF is located at the front surface of the stacked electrode body 20B, and the side surface 20Br is located at the rear surface of the stacked electrode body 20. The side surface 21BF is located at the front surface of the stacked electrode body 20B, and the side surface 21Br is located at the rear surface of the stacked electrode body 21B. Thus, separators 26 are folded in different ways between the stacked electrode body 20B and the stacked electrode body 21B. In the stacked electrode body 20B, a first end portion 26e1 and a second end portion 26e2 are located forward of positive electrode sheets 22 and negative electrode sheets 24, and the separator 26 is folded. In the stacked electrode body 21B, a first end portion 26e1 and a second end portion 26e2 are located rearward of positive electrode sheets 22 and negative electrode sheets 24, and the separator 26 is folded.

In the third embodiment, the side surfaces to which the tapes 29 are fastened in the stacked electrode bodies 20 located at positions facing a pair of opposed side surface portions 12b of the case body 12 are oriented toward the side surface portions 12b of the case body 12. More specifically, the side surface 20BF of the stacked electrode body 20B is oriented toward the side surface portion 12ba, and the side surface 21Br of the stacked electrode body 21B is oriented toward the side surface portion 12bb.

When the power storage device 100B is charged and the stacked electrode body 20B and the stacked electrode body 21B expand in the thickness directions Y, the tape 29 fastened to the side surface 20BF of the stacked electrode body 20B contacts the side surface portion 12ba and is subjected to a normal force from the side surface portion 12ba. In addition, the tape 29 fastened to the side surface 21Br of the stacked electrode body 21B contacts the side surface portion 12bb and is subjected to a normal force from the side surface portion 12bb. At this time, the side surface 20Br of the stacked electrode body 20B and the side surface 21BF of the stacked electrode body 21B contact each other to be pushed against each other. Accordingly, the electrolyte 15 that has infiltrated into the stacked electrode body 20B and the stacked electrode body 21B is extruded.

In the third embodiment described above, the tape 29 of the stacked electrode body 20B and the tape 29 of the stacked electrode body 21B are subjected to normal forces from the pair of opposed side surface portions 12b. Thus, the stacked electrode body 20B and the stacked electrode body 21B are disposed such that the vicinity of the thickest portion of the stacked electrode body 20B and the vicinity of the thickest portion of the stacked electrode body 21B easily receive forces from the pair of opposed side surface portions 12b. Accordingly, the amount of extrusion of the electrolyte 15 and the amount of absorption of the electrolyte 15 become relatively large, and the electrolyte 15 is likely to circulate inside and outside the stacked electrode body 20B and the stacked electrode body 21B. Consequently, occurrence of liquid shortage of the electrolyte 15 is suppressed inside and outside the stacked electrode body 20B and the stacked electrode body 21B.

### Fourth Embodiment

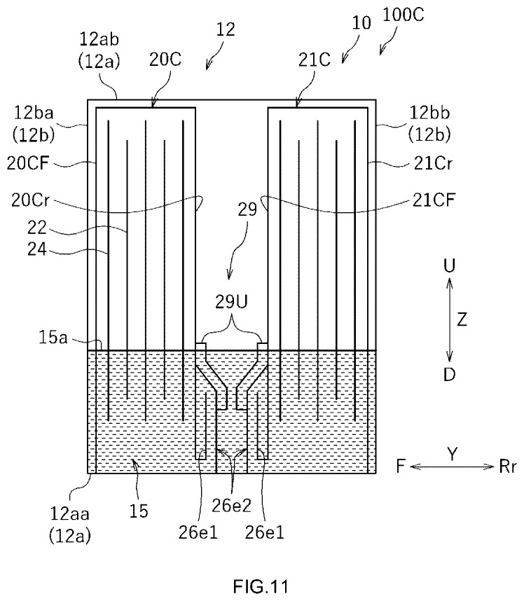

FIG. 11 is a schematic view illustrating inside of a power storage device 100C according to a fourth embodiment. As illustrated in FIG. 11, a stacked electrode body 20C and a stacked electrode body 21C are housed in a case 10. The stacked electrode body 20C is located forward of the stacked electrode body 21C. A side surface of the stacked electrode body 20C to which a tape 29 is fastened will be referred to as a side surface 20Cr. A surface of the stacked electrode body 20C opposite to the side surface 20Cr in the thickness directions Y will be referred to as a side surface 20CF. A side surface of the stacked electrode body 21C to which the tape 29 is fastened will be referred to as a side surface 21CF. A surface of the stacked electrode body 21C opposite to the side surface 21CF in the thickness directions Y will be referred to as a side surface 21Cr. The side surface 20Cr is located at the rear surface of the stacked electrode body 20C, and the side surface 20CF is located at the front surface of the stacked electrode body 20C. The side surface 21CF is located at the front surface of the stacked electrode body 21C, and the side surface 21Cr is located at the rear surface of the stacked electrode body 21C. Thus, separators 26 are folded in different ways between the stacked electrode body 20C and the stacked electrode body 21C. In the stacked electrode body 20C, a first end portion 26e1 and a second end portion 26e2 are located rearward of positive electrode sheets 22 and negative electrode sheets 24, and the separator 26 is folded. In the stacked electrode body 21C, a first end portion 26e1 and a second end portion 26e2 are located forward of positive electrode sheets 22 and negative electrode sheets 24, and the separator 26 is folded.

In the fourth embodiment, side surfaces of the stacked electrode body 20C and the stacked electrode body 21C to which the tapes 29 are fastened face the opposite sides to a pair of opposed side surface portions 12b of the case body 12. More specifically, the side surface 20Cr of the stacked electrode body 20C is located on the side opposite to the side surface portion 12ba in the thickness directions Y. The side surface 21CF of the stacked electrode body 21C is located on the side opposite to the side surface portion 12bb in the thickness directions Y. Accordingly, the side surface 20Cr and the side surface 21CF face each other.

When the power storage device 100C is charged and the stacked electrode body 20C and the stacked electrode body 21C expand in the thickness directions Y, the side surface 20CF of the stacked electrode body 20C contacts the side surface portion 12ba and is subjected to a normal force from the side surface portion 12ba. In addition, the side surface 21Cr of the stacked electrode body 21C contacts the side surface portion 12bb and is subjected to a normal force from the side surface portion 12bb. At this time, the tape 29 of the stacked electrode body 20C and the tape 29 of the stacked electrode body 21C contact each other, and forces are applied in the thickness directions Y to the vicinities of the thickest portions of the stacked electrode body 20C and the stacked electrode body 21C. Accordingly, the electrolyte 15 that has infiltrated into the stacked electrode body 20C and the stacked electrode body 21C is extruded.

In the fourth embodiment described above, the stacked electrode body 20C receives a normal force from the side surface portion 12ba, and the stacked electrode body 21C receives a normal force from the side surface portion 12bb Accordingly, the tape 29 of the stacked electrode body 20C and the tape 29 of the stacked electrode body 21C are pushed in the thickness directions Y, and the vicinities of the thickest portions of the stacked electrode body 20C and the stacked electrode body 21C are pushed. Since no tapes 29 are fastened to the side surface 20CF of the stacked electrode body 20C and the side surface 21Cr of the stacked electrode body 21C, the side surface 20CF and the side surface 21Cr are relatively flat. Thus, forces applied to the side surface 20CF and the side surface 21Cr are less likely to vary depending on the position in the top-bottom directions Z. Accordingly, when the stacked electrode body 20C and the stacked electrode body 21C expand to contact the pair of side surface portions 12b, normal forces received from the pair of side surface portions 12b are less likely to be decomposed in directions other than the thickness directions Y. Consequently, the amount of extrusion of the electrolyte 15 from the stacked electrode body 20C and the stacked electrode body 21C and the amount of absorption of the electrolyte 15 in the stacked electrode body 20C and the stacked electrode body 21C become relatively large. The electrolyte 15 is likely to circulate inside and outside the stacked electrode body 20C and the stacked electrode body 21C. This suppresses occurrence of liquid shortage of the electrolyte 15 inside and outside the stacked electrode body 20C and the stacked electrode body 21C.

Various examples of the present disclosure have been described. Unless otherwise specified, the embodiments and other examples mentioned herein do not limit the present disclosure. The embodiments disclosed here can be modified in various ways, and the constituent elements and the processes described here can be appropriately omitted or appropriately combined unless no particular problems arise.

As described above, the specification includes the disclosures described in the following items.

### Item 1

A secondary battery includes:
an electrode body including a plurality of first electrode sheets, a plurality of second electrode sheets with a polarity different from that of the first electrode sheets, and a separator;
an electrolyte;
a cylindrical case body housing the electrode body and the electrolyte;
a first sealing plate attached to an opening of the case body on a first side; and
a second sealing plate attached to an opening of the case body on a second side, wherein
the case body includes a pair of opposed side surface portions,
the plurality of first electrode sheets and the plurality of second electrode sheets face the pair of opposed side surface portions in the case body and are alternately arranged,
the separator has a band shape, is folded in turn, and sequentially passes between the first electrode sheets and the second electrode sheets to be thereby located between the first electrode sheets and the second electrode sheets,
the separator includes a first end portion that is located at an outer circumference of the electrode body in which the plurality of first electrode sheets and the plurality of second electrode sheets alternately face each other,
the separator includes a second end portion that is located at the outer circumference of the electrode body in which the plurality of first electrode sheets and the plurality of second electrode sheets are alternately face each other, and overlaid on an outer side of the first end portion and fastened to the outer circumference of the electrode body by a tape, and
in a state where the pair of opposed side surface portions of the case body is oriented vertically, an upper edge of the second end portion of the separator fastened by the tape is located below a liquid level of the electrolyte outside the electrode body in the case body.

### Item 2:

In the secondary battery of Item 1, an upper end of the tape is located above the liquid level of the electrolyte.

### Item 3:

In the secondary battery of Item 1, an upper end of the tape is located below the liquid level of the electrolyte.

### Item 4:

In the secondary battery of any one of Items 1 to 3, the tape includes a plurality of tapes intermittently arranged along the upper edge of the second end portion.

### Item 5:

In the secondary battery of any one of Items 1 to 4, in a portion of the separator fastened to the outer circumference of the electrode body by the tape, the second end portion of the separator is longer than the first end portion of the separator.

### Item 6:

In the secondary battery of any one of Items 1 to 5, in a portion of the separator fastened to the outer circumference of the electrode body by the tape, the second end portion of the separator includes a heat resistance layer on an inner side of the electrode body.

### Item 7:

In the secondary battery of any one of Items 1 to 6, in a state where the pair of opposed side surface portions of the case body is oriented vertically with an SOC of 75% or more, the first end portion and the second end portion of the separator fastened by the tapes are located below the liquid level of the electrolyte outside the electrode body.

### Item 8:

In the secondary battery of any one of Items 1 to 7,
the electrode body comprises a plurality of electrode bodies arranged along the pair of opposed side surface portions of the case body while facing the pair of opposed side surface portions, and
in each of the plurality of electrode bodies, in a state where the pair of opposed side surface portions of the case body is oriented vertically, an upper edge of the second end portion of the separator fastened by the tape is located below the liquid level of the electrolyte outside the electrode body in the case body.

### Item 9:

In the secondary battery of any one of Items 1 to 8, a side surface of the electrode body to which the tape is fastened is oriented toward an identical side surface of the pair of opposed side surface portions of the case body.

### Item 10:

In the secondary battery of any one of Items 1 to 8, a side surface fastened by the tape in the electrode body located at a position facing the pair of opposed side surface portions of the case body is oriented toward the side surface portions of the case body.

### Item 11:

In the secondary battery of any one of Items 1 to 8, a side surface of the electrode body fastened by the tape is located on an opposite side to the pair of opposed side surface portions of the case body.

### Item 12:

The secondary battery of any one of Items 1 to 11 further includes:
a first terminal located on the first sealing plate; and
a second terminal located on the second sealing plate, wherein
each of the plurality of first electrode sheets includes a first electrode tab extending toward the first sealing plate and connected to the first terminal, and
each of the plurality of second electrode sheets includes a second electrode tab extending toward the second sealing plate and connected to the second terminal.

What is claimed is:

1. A secondary battery comprising:
an electrode body including a plurality of first electrode sheets, a plurality of second electrode sheets with a polarity different from that of the first electrode sheets, and a separator;
an electrolyte;
a cylindrical case body housing the electrode body and the electrolyte;
a first sealing plate attached to an opening of the case body on a first side; and
a second sealing plate attached to an opening of the case body on a second side, wherein
the case body includes a pair of opposed side surface portions,
the plurality of first electrode sheets and the plurality of second electrode sheets face the pair of opposed side surface portions in the case body and are alternately arranged,
the separator has a band shape, is folded in turn, and sequentially passes between the first electrode sheets and the second electrode sheets to be thereby located between the first electrode sheets and the second electrode sheets,
the separator includes a first end portion that is located at an outer circumference of the electrode body in which the plurality of first electrode sheets and the plurality of second electrode sheets alternately face each other,
the separator includes a second end portion that is located at the outer circumference of the electrode body in which the plurality of first electrode sheets and the plurality of second electrode sheets are alternately face each other, and overlaid on an outer side of the first end portion and fastened to the outer circumference of the electrode body by a tape, and
in a state where the pair of opposed side surface portions of the case body is oriented vertically, an upper edge of the second end portion of the separator fastened by the tape is located below a liquid level of the electrolyte outside the electrode body in the case body.

2. The secondary battery according to claim 1, wherein an upper end of the tape is located above the liquid level of the electrolyte.

3. The secondary battery according to claim 1, wherein an upper end of the tape is located below the liquid level of the electrolyte.

4. The secondary battery according to claim 1, wherein the tape comprises a plurality of tapes intermittently arranged along the upper edge of the second end portion.

5. The secondary battery according to claim 1, wherein in a portion of the separator fastened to the outer circumference of the electrode body by the tape, the second end portion of the separator is longer than the first end portion of the separator.

6. The secondary battery according to claim 1, wherein in a portion of the separator fastened to the outer circumference of the electrode body by the tape, the second end portion of the separator includes a heat resistance layer on an inner side of the electrode body.

7. The secondary battery according to claim 1, wherein in a state where the pair of opposed side surface portions of the case body is oriented vertically with an SOC of 75% or more, the first end portion and the second end portion of the separator fastened by the tapes are located below the liquid level of the electrolyte outside the electrode body.

8. The secondary battery according to claim 1, wherein
the electrode body comprises a plurality of electrode bodies arranged along the pair of opposed side surface portions of the case body while facing the pair of opposed side surface portions, and
in each of the plurality of electrode bodies, in a state where the pair of opposed side surface portions of the case body is oriented vertically, an upper edge of the second end portion of the separator fastened by the tape is located below the liquid level of the electrolyte outside the electrode body in the case body.

9. The secondary battery according to claim 1, wherein a side surface of the electrode body to which the tape is fastened is oriented toward an identical side surface of the pair of opposed side surface portions of the case body.

10. The secondary battery according to claim 1, wherein a side surface fastened by the tape in the electrode body located at a position facing the pair of opposed side surface portions of the case body is oriented toward the side surface portions of the case body.

11. The secondary battery according to claim 1, wherein a side surface of the electrode body fastened by the tape is located on an opposite side to the pair of opposed side surface portions of the case body.

12. The secondary battery according to claim 1, further comprising:
a first terminal located on the first sealing plate; and
a second terminal located on the second sealing plate, wherein
each of the plurality of first electrode sheets includes a first electrode tab extending toward the first sealing plate and connected to the first terminal, and
each of the plurality of second electrode sheets includes a second electrode tab extending toward the second sealing plate and connected to the second terminal.
